(19) United States
(12) Patent Application Publication
(10) Pub. No.: US 2012/0218864 A1
(43) Pub. Date: Aug. 30, 2012

(54) MULTICHANNEL TRANSDUCER ARRAY FOR A BATHYMETRY SONAR DEVICE

(76) Inventor: Olexandr Ivanov, Coquitlam (CA)

(21) Appl. No.: 13/037,179

(22) Filed: Feb. 28, 2011

(51) Int. Cl. G01S 15/00

(52) U.S. Cl. 367/87

(57) ABSTRACT

A transducer array comprises an elongate support with first and second channels. The first channel has a bottom and a pair of opposed side walls extending from the bottom thereof. The second channel also has a bottom and a pair of opposed side walls extending from the bottom thereof. There is a first transducer element disposed in the first channel and a spacer disposed between the first transducer element and the bottom of the first channel. There is a second transducer element disposed in the second channel and a spacer disposed between the second transducer element and the bottom of the second channel.

### BACKGROUND OF THE INVENTION

1. Field of the Invention

The present invention relates to a bathymetry device and, in particular, to a multichannel transducer array for a bathymetry device.

2. Description of the Related Art

It is known to use sonar devices in fishing, treasure hunting and bathymetry applications. For example U.S. Pat. No. 5,142,503 issued to Wilcox et al. on Aug. 25, 1992, and the full disclosure of which is incorporated herein by reference, discloses a sonar device constructed from a solid polyvinyl chloride (PVC) rod. The PVC rod is milled and slotted to provide recesses for electronics and transducers. The PVC rod is also slotted to provide attachment points for fins and a tow rail. The towfish is then filled and sealed with urethane thereby providing a sealed solid unit which is waterproof.

A special multilayer acoustic matching system is bonded over the transducers to provide maximum coupling efficiency of the acoustic signal. The multilayer acoustic matching system includes multiple plates of materials which have successively lower acoustic impedance in the direction of acoustic propagation. Each plate is one-quarter wavelength thick at the resonant frequency of the transducer. The effect of the matching system is to improve the efficiency of the transducer and increase its bandwidth, thereby allowing operation of the towfish at reduced power requirements.

U.S. Pat. No. 7,710,825 issued to Betts et al. on Mar. 4, 2010, and the full disclosure of which is also incorporated herein by reference, discloses a system for use with a boat to provide underwater sonar images. The system includes a left side scan sonar transducer and right scan sonar transducer. The left side scan sonar transducer transmits and receives left side acoustic signals. The right side scan sonar transducer transmits and receives right side acoustic signals. There is signal processing circuitry for processing the left and right side acoustic signals to side scan sonar image data. There is also a digital processor for providing signals to a display based upon the side scan image data to produce a display image on the display showing boat location, a water column between the boat and bottom, and an underwater image comprising at least one of a left side underwater image and a right side underwater image. The transducers are disposed in an acoustic shield which surrounds all but one side of each transducer to prevent acoustic signals from being transmitted and received in all but a desired direction.

In the above described bathymetry devices, and other conventional bathymetry devices, the quality of the images generated is dependent on the transducers being acoustically isolated as well as on focused transmission and receipt of acoustic signals. There is accordingly an ongoing need for an improved transducer array for a bathymetry device.

### SUMMARY OF THE INVENTION

It is an object of the present invention to provide an improved bathymetry device for use in bathymetry and side scan applications.

It is another object of the present invention to provide an improved multichannel transducer array for a bathymetry sonar device used in bathymetry and side scan applications.

It is yet another object of the present invention to provide an improved multichannel transducer array for a bathymetry device in which the channels are closely positioned but acoustically isolated.

There is accordingly provided a transducer array for a bathymetry sonar device. The transducer array comprises an elongate support with first and second channels. The first channel has a bottom and a pair of opposed side walls extending from the bottom thereof. The second channel also has a bottom and a pair of opposed side walls extending from the bottom thereof. There is a first transducer element disposed in the first channel and a spacer disposed between the first transducer element and the bottom of the first channel. There is a second transducer element disposed in the second channel and a spacer disposed between the second transducer element and the bottom of the second channel. In one embodiment the first channel and second channel are parallel.

The transducer array may further include a spacer disposed between the first transducer element and at least one of the opposed side walls of the first channel. A polyurethane filler may seal the first transducer in the first channel. The elongate support is preferably constructed of a reflective material capable of reflecting acoustic signals. A distance between a center of the first channel and a center of the second channel is half a wavelength of a resonant frequency of the first transducer element in water. There may be a third channel with the first, second and third channels being spaced equidistantly. The transducer element may include a plurality of piezoelectric composite elements arranged end to end along the channel.

There is also provided a bathymetry device comprising an elongate housing having a recess and a transducer array disposed in the recess of the elongate housing. The transducer array includes an elongate support with first and second channels. The first channel has a bottom and a pair of opposed side walls extending from the bottom thereof. The second channel also has a bottom and a pair of opposed side walls extending from the bottom thereof. There is a first transducer element disposed in the first channel and a spacer disposed between the first transducer element and the bottom of the first channel.

There is a second transducer element disposed in the second channel and a spacer disposed between the second transducer element and the bottom of the second channel. A polyurethane filler seals the transducer array in the recess of the elongate housing.

The bathymetry sonar device may further include a holder disposed in the recess of the elongate housing, wherein the transducer array is set in the mounting. The holder is preferably constructed from polyvinyl chloride. The polyurethane filler seals the holder in the recess of the elongate housing.

The bathymetry sonar device may still further include an acoustic shield disposed adjacent to the transducer array. The polyurethane filler seals the acoustic shield in the recess of the elongate housing.

The bathymetry sonar device may yet still further include a transmitter and an acoustic muffler. Preferably the transmitter and transducer array are both disposed along a longitudinal axis of the bathymetry device, and the acoustic muffler is disposed between the transmitter and transducer array. The acoustic muffler includes a plurality of spaced apart plates extending generally perpendicular to the longitudinal axis of the bathymetry sonar device.

The transducer array and bathymetry device disclosed herein provide the advantage of acoustically isolating transducer elements in a multichannel transducer array for a bathymetry device used bathymetry and side scan applications.

### BRIEF DESCRIPTIONS OF DRAWINGS

The invention will be more readily understood from the following description of the embodiments thereof given, by way of example only, with reference to the accompanying drawings, in which:

FIG. 1 is a perspective view showing a first embodiment of an improved bathymetry device;

FIG. 2 is a top plan, partially sectional view showing the bathymetry device of FIG. 1;

FIG. 3 is an enlarged, fragmentary view of portion 3 of the FIG. 2 showing a muffler of the bathymetry device of FIG. 1;

FIG. 4 is a sectional view taken along line 4-4 of FIG. 3 showing ribs of the muffler of the bathymetry device of FIG. 1;

FIG. 5 is a sectional view taken along line 5-5 of FIG. 2 showing a multichannel transducer array of the bathymetry device of FIG. 1;

FIG. 6 is a perspective view showing a support for the transducer array of the bathymetry device of FIG. 1;

FIG. 7 is a front elevation view showing the support for the transducer array of the bathymetry device of FIG. 1;

FIG. 8 is a perspective, fragmentary view showing a transducer element of the transducer array of the bathymetry device of FIG. 1;

FIG. 9 is a sectional view showing a second embodiment of an improved bathymetry device;

FIG. 10 is a sectional view showing a third embodiment of an improved bathymetry device;

FIGS. 11 to 13 are schematics showing geometric parameters of various embodiments of a multichannel transducer array of the bathymetry device of FIG. 1; and

FIGS. 14 to 17 are schematics showing various further embodiments of an improved bathymetry device.

### DESCRIPTIONS OF THE PREFERRED EMBODIMENTS

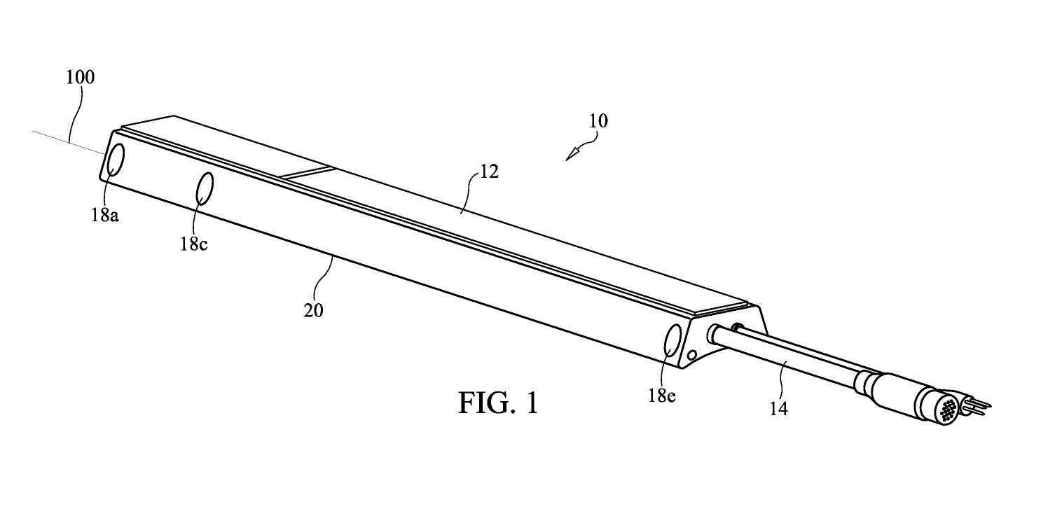

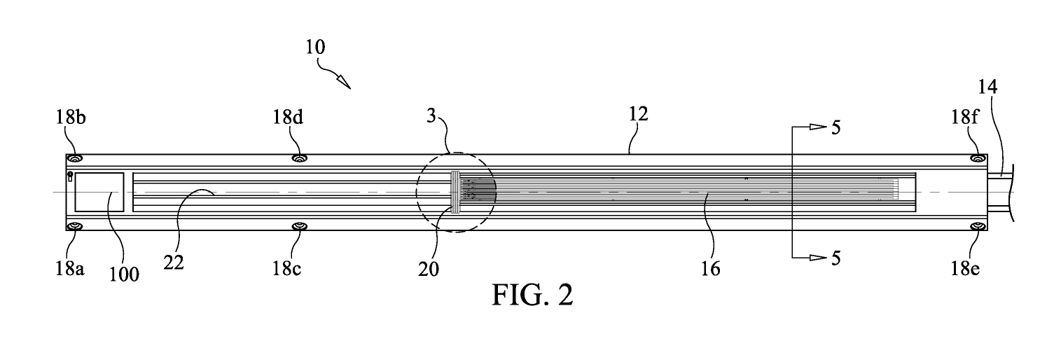

Referring to the drawings and first to FIGS. 1 and 2 this shows a first embodiment of an improved bathymetry device 10. The bathymetry device 10 generally includes a body 12 and a pigtail connection 14. The body 12 encases a multichannel transducer array 16 which is shown in FIG. 2. The pigtail connection 14 is for connecting the body 12, and the transducer array 16 disposed therein, to an electronic control head (not shown). There is a plurality of mounting holes 18a, 18b, 18c, 18d, 18e and 18f in the body 12 which allow the bathymetry device 10 to be mounted on a towfish or a hull of a marine vessel as is well known in the art. As thus far described the bathymetry device 10 is generally conventional.

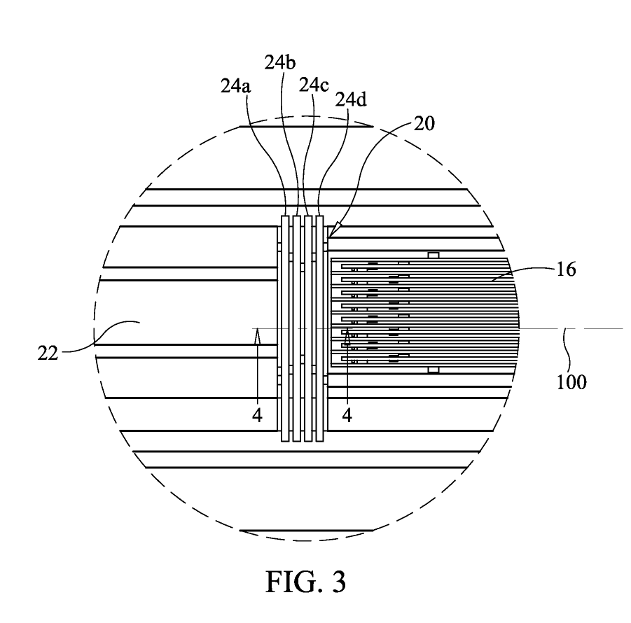

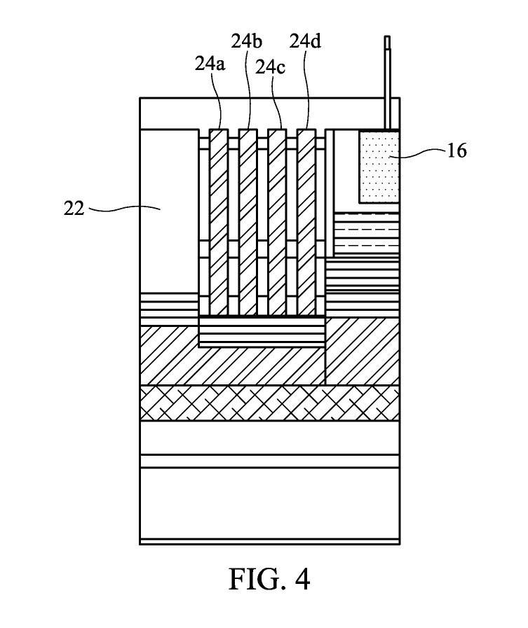

However, as best shown in FIG. 2, the bathymetry device 10 is provided with an improved acoustic muffler 20 disposed between the transducer array 16 and a transmitter 22 of the bathymetry device 10. The muffler 20, shown in greater detail in FIGS. 3 and 4, includes a plurality of ribs 24a, 24b, 24c and 24d which extend substantially perpendicular to the transducer array 16. In this example the ribs are formed from mild steel or stainless steel and are spaced approximately 0.040 inches apart. However, other suitable materials and spacing may be used. The acoustic muffler 20 allows for both the transducer array 16 and transmitter 22 to extend along a longitudinal axis 100, as best shown in FIG. 2, of the bathymetry device 10.

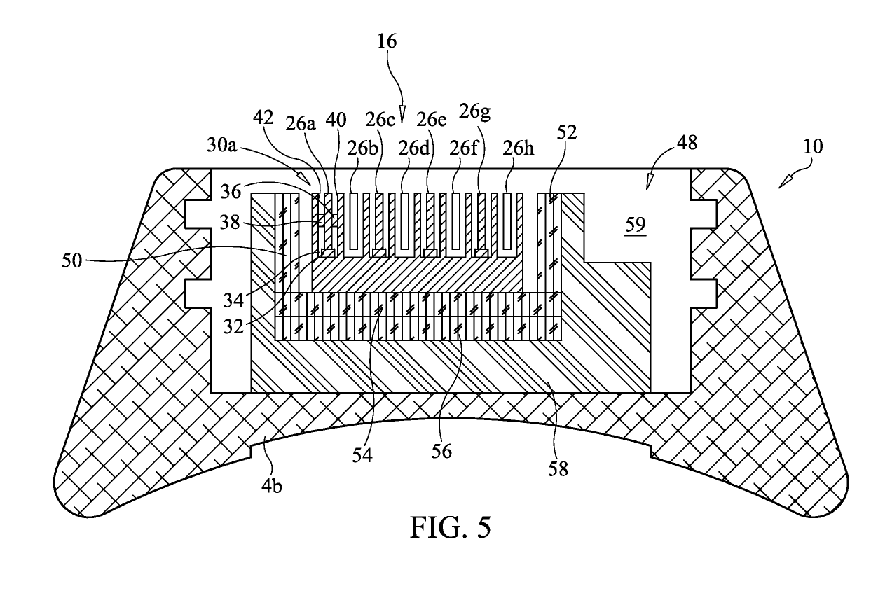

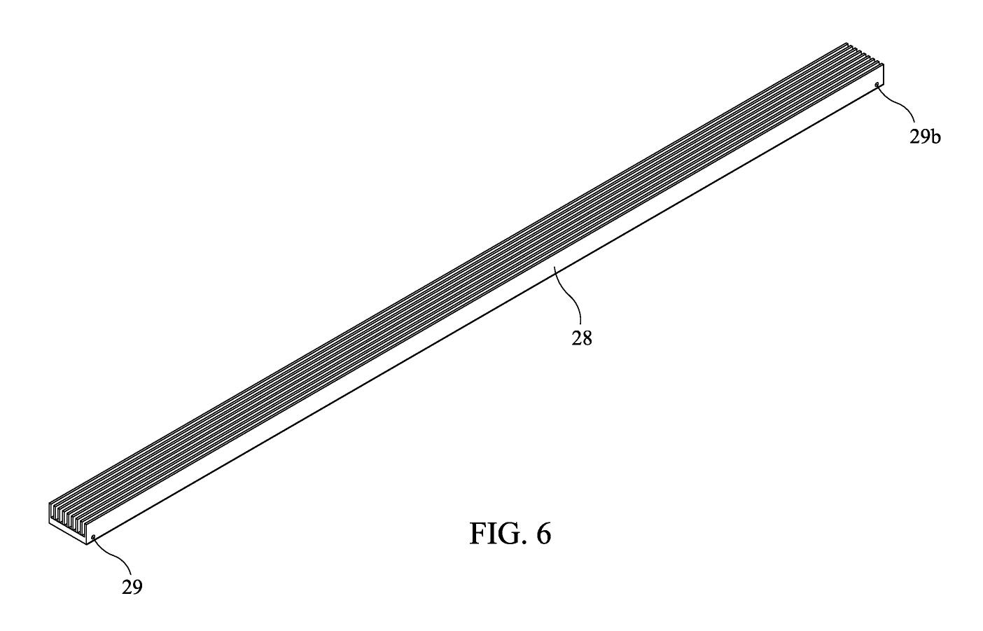

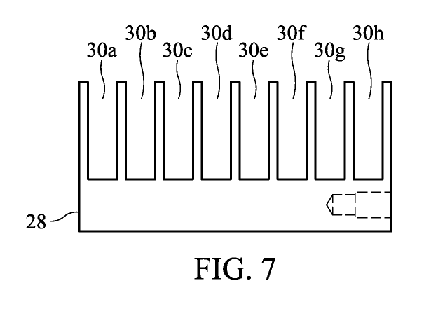

Referring now to FIG. 5 the transducer array 16 of the bathymetry device 10 is showing in greater detail. The transducer array 16 includes a plurality transducer elements 26a, 26b, 26c, 26d, 26e, 26f, 26g and 26h on a support 28. The transducer elements are substantially similar in structure and function. Accordingly, only one of the transducer elements 26a is described in detail herein with the understanding that the remaining transducer elements 26b, 26c, 26d, 26e, 26f, 26g and 26h have a substantially similar structure and function in a substantially similar manner. The support 28, best shown in FIGS. 6 and 7, is an elongate support with a plurality of parallel channels 30a, 30b, 30c, 30d, 30e, 30f, 30g and 30h extending a length thereof. The channels are substantially similar in structure and function. Accordingly, only one of the channels 30a is described in detail herein with the understanding that the remaining channels 30b, 30c, 30d, 30e, 30f, 30g and 30h have a substantially similar structure and function in a substantially similar manner.

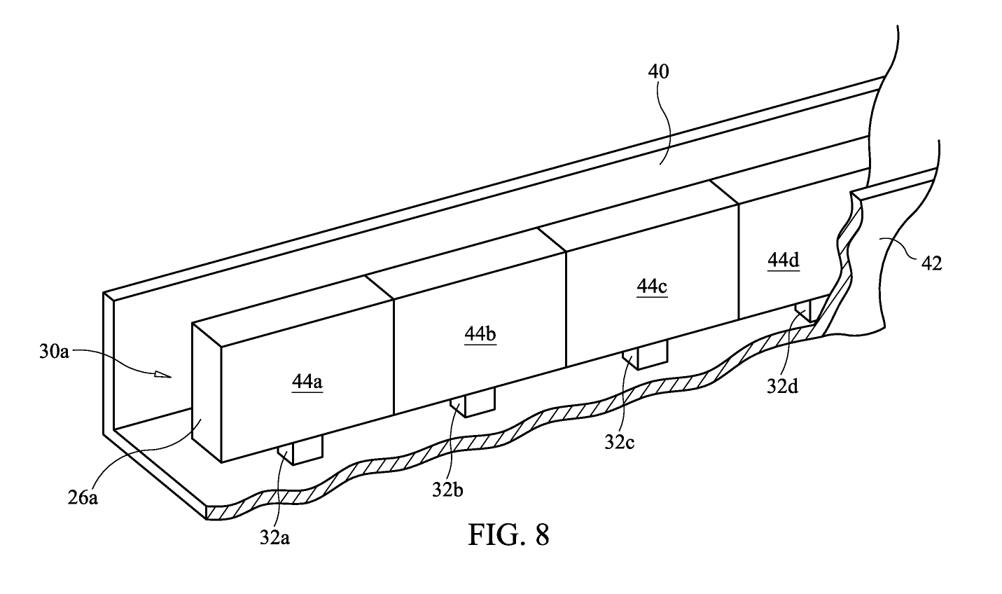

In this example, the support 28 is constructed from bronze but any suitable reflective material may be used to construct the support 28, thereby causing the channels to reflect the acoustic signals. There are mounting holes 29a and 29b at each end of the support 28. Each of the transducer elements is disposed in a corresponding channel, for example and as shown in FIG. 5, transducer element 26a is disposed in channel 30a. There is spacer 32 between the transducer element 26a and a bottom 34 of the channel 30a. The spacer 32 prevents the transducer element 26a from contacting the bottom 34 of the channel 30a. There are also spacers 36 and 38 which respectively prevent the transducer element 26a from contacting opposed side walls 40 and 42 of the channel 30a. The spacers 32, 36 and 38 are dielectric elements. The channel 30a is open ended in this example (i.e. there are no end walls) and, as shown in FIG. 8, the transducer element 26a includes a plurality of piezoelectric composite elements, for example, piezoelectric composite elements 44a, 44b, 44c and 44d arranged end to end along a length of the channel 30a. The piezoelectric composite elements 44a, 44b, 44c and 44d are set on corresponding spacers 32a, 32b, 32c and 32d.

Referring back to FIG. 5, the bathymetry device 10 includes a housing 46 which, in this example, is constructed from aluminum. The housing 46 has a longitudinal recess 48 in which the support 28 is disposed. There are plates 50, 52, 54 and 56 constructed from an acoustically absorptive material which are strategically placed adjacent and around the support 28. The plates 50, 52, 54 and 56 function as acoustic shields. Plates 50 and 52 extending lateral of the support 28, and on opposite sides of the support 28, for the entire length of the support 28. Plates 54 and 56 are stacked and extend below the support 28 for the entire length of the support 28. Plates 50 and 52 are generally perpendicular to plates 54 and 56. In this example, the support 28 and 50, 52, 54 and 56 plates is set in a polyvinyl chloride (PVC) mounting or holder 58 which also functions to acoustically isolate the transducer array 16. Alternatively, the holder 58 may be constructed from cork or other low density materials. The transducer array is sealed in the recess 48 of the housing 46 with polyurethane 59. The transducer array 16 is thereby acoustical isolated as required for proper functioning of the bathymetry sonar device 10.

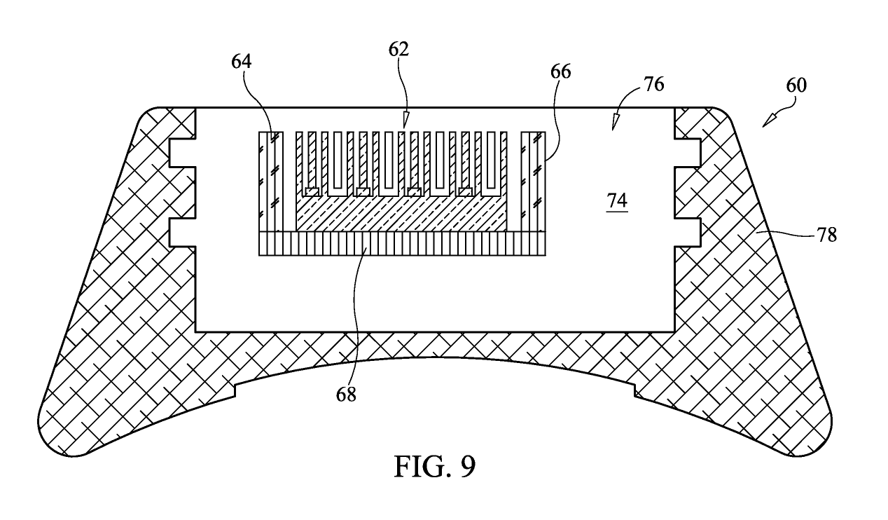

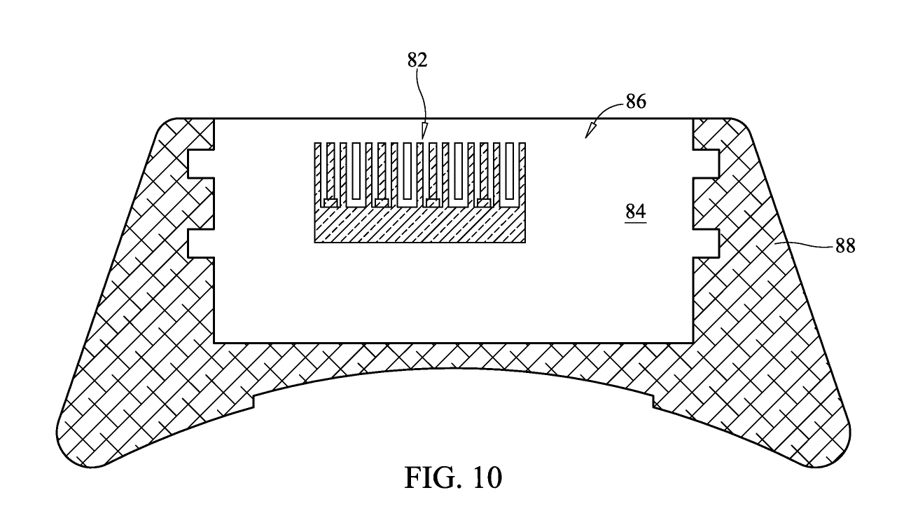

It will be understood by a person skilled in the art that in other embodiments of the bathymetry device may not be provided with the holder and acoustic shields. FIG. 9 shows a second embodiment of an improved bathymetry device 60 in which a transducer array 62 is not set on a holder. The transducer array 62 is merely surrounded by acoustic shields 64, 66 and 68, and sealed by polyurethane 74 in a recess 76 of a housing 78. FIG. 10 shows a third embodiment of an improved bathymetry device 80 in which a transducer array 82 is not set in a holder or surrounded by acoustic shields. The transducer array 82 is merely sealed by polyurethane 84 in a recess 86 of a housing 88.

Aside from the above-mentioned difference the embodiments of FIGS. 9 and 10 are similar to the embodiment of FIGS. 1 to 8.

It will further be understood by a person skilled in the art that in other embodiments of the invention the support may not necessarily have eight channels as shown in the embodiments of FIGS. 1 to 10. The support may be provided with any number of channels.

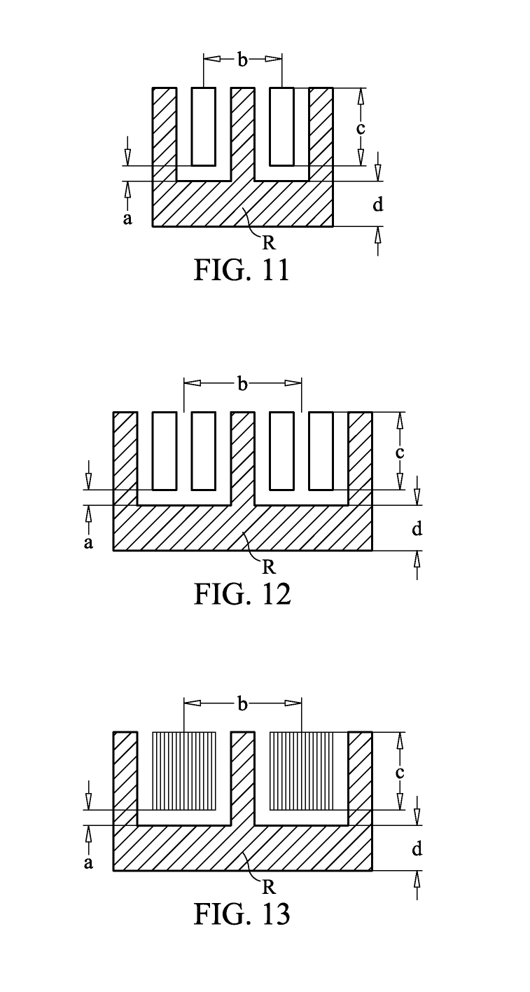

The underlying principle of the present invention is providing closely positioned but acoustically isolated channels in a multichannel array. Channel isolation is achieved largely by means of improved boundary conditions and without the required use of any acoustically absorptive materials. In particular, acoustic isolation is achieved by providing a desired cross-sectional geometry of a multichannel transducer array. A length of the transducer array may be any expansion that is usually governed by beam requirements. Every channel in the array may include one or more piezoelectric components. It is known that the resonant frequencies of the piezoelectric components is governed by material properties, aspect ratios and the thickness of the piezoelectric elements which is shown as parameter C in FIGS. 11 to 13. It is also known in order for a transducer array to provide an unambiguous 180 degree field of view a center distance between channels must be equal or less than ½ λ, where λ is an acoustic wavelength of the resonant frequency of the piezoelectric elements in water. It is therefore desirable to provide an array geometry as described and shown in FIGS. 11 to 13 where B=½ λ. However, for narrower beams parameter B may be relaxed and exceed ½ λ.

It is only required that the array be comprised of identical resonant channels including piezoelectric elements with the same or otherwise close aspect ratios, cross-sectional dimensions and resonant frequencies. All channels in the transducer array are spaced equidistantly as shown by parameter B in FIGS. 11 to 13. Without limitation, the number of channels in the array may be N≧2. Without any limitation the individual elements within any channel may be one or more as shown in FIGS. 11 and 12. Without any limitation every individual piezoelectric element may contain multiple inseparable sub-elements as shown for the piezoelectric elements of FIG. 13.

All components in the transducer array should be flat, square, parallel and with a good surface finish. In particular, the support functions as a reflector (R) should meet certain components. The reflector (R) should have a high acoustic impendence Z_{R}=p·v where p is density (kg/m³) and v is the speed of sound (m/s). The reflector (R) should support a high surface finish to improve boundary conditions. The reflector (R) is electrically conductive in order to provide electrical shielding to the piezoelectric elements. The acoustic impedance of the encapsulating material, polyurethane in this example, should be low in order to provide correct boundary conditions Z_{E}<<Z_{R}. The reflector may be constructed of any suitable heavy metal or alloy, for example, copper, brass, iron, steel, etc.

The device may be provided with the following parameters, as shown in FIGS. 11 to 13, although any suitable parameters may be used.

A=¼·λ_{E} where λ_{E} is an acoustic wavelength in the polyurethane filler.

B=¼·λ_{R} where λ_{R} is an acoustic wavelength in the support or reflector.

The piezoelectric elements in the array are isolated from the electrically conductive reflectors by means of small dielectric spacers.

Immediately below the reflector (R) there is a layer of material with the lowest acoustic impedance and/or a combination of such material with another absorptive material or any combination of those with additional reflectors. This may be required for correct boundary conditions to take place.

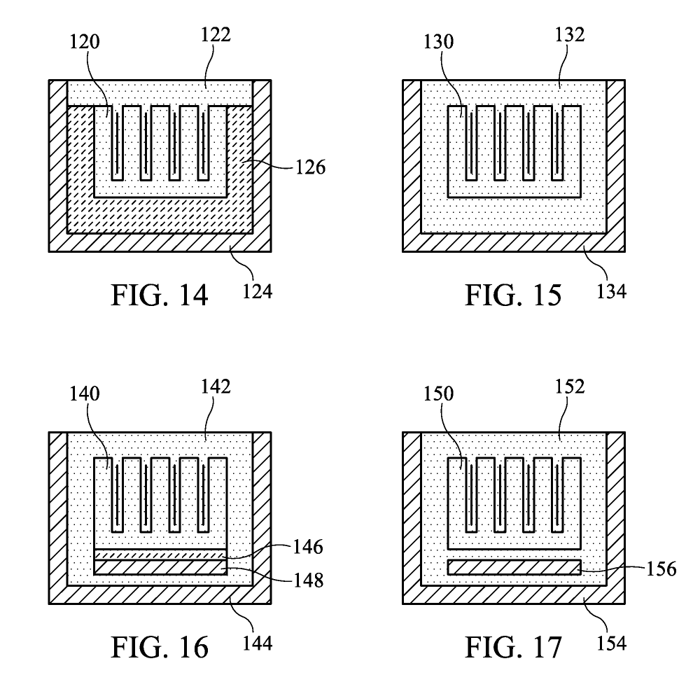

FIG. 14 shows a schematic in which the outline of the support or reflector is indicated generally by reference numeral 120. The encapsulant or polyurethane filler is indicated generally by reference numeral 122. The housing is indicated generally by reference numeral 124 and the absorptive material or acoustic shield is indicated generally by reference numeral 126.

FIG. 15 shows a schematic in which the outline of the support or reflector is indicated generally by reference numeral 130. The encapsulant or polyurethane filler is indicated generally by reference numeral 132. The housing is indicated generally by reference numeral 134.

FIG. 16 shows a schematic in which the outline of the support or reflector is indicated generally by reference numeral 140. The encapsulant or polyurethane filler is indicated generally by reference numeral 142. The housing is indicated generally by reference numeral 144. The absorptive material, also referred to herein as an acoustic shield, is indicated generally by reference numeral 146 and an additional metal reflector is indicated generally by reference numeral 148.

FIG. 17 shows a schematic in which the outline of the support or reflector is indicated generally by reference numeral 150. The encapsulant or polyurethane filler is indicated generally by reference numeral 152. The housing is indicated generally by reference numeral 154 an additional metal reflector is indicated generally by reference numeral 156.

It will still further be understood by a person skilled in the art that many of the details provided above are by way of example only, and are not intended to limit the scope of the invention which is to be determined with reference to the following claims.

What is claimed is:

1. A transducer array for a bathymetry sonar device, the transducer array comprising:
an elongate support;
a first channel in the support, the first channel having a bottom and a pair of opposed side walls extending from the bottom thereof;
a second channel in the support, the second channel having a bottom and a pair of opposed side walls extending from the bottom thereof;
a first transducer element disposed in the first channel and a spacer disposed between the first transducer element and the bottom of the first channel; and
a second transducer element disposed in the second channel and a spacer disposed between the second transducer element and the bottom of the second channel.

2. The transducer array as claimed in claim 1 wherein the first channel and second channel are parallel.

3. The transducer array as claimed in claim 1 further including a spacer disposed between the first transducer element and at least one of the opposed side walls of the first channel.

4. The transducer array as claimed in claim 1 wherein further including a polyurethane filler sealing the first transducer in the first channel.

5. The transducer array as claimed in claim 1 wherein the elongate support is constructed of a reflective material capable of reflecting acoustic signals.

6. The transducer array as claimed in claim 1 wherein a distance between a center of the first channel and a center of the second channel is half a wavelength of a resonant frequency of the first transducer element in water.

7. The transducer array as claimed in claim 1 further including a third channel wherein the first, second and third channels are spaced equidistantly.

8. The transducer array as claimed in claim 1 wherein the first transducer element includes a plurality of piezoelectric composite elements arranged end to end along the first channel.

9. A bathymetry sonar device comprising:
an elongate housing having a recess; and
a transducer array disposed in the recess of the elongate housing, the transducer array including:
an elongate support;
a first channel in the support, the first channel having a bottom and a pair of opposed side walls extending from the bottom thereof;
a second channel in the support, the second channel having a bottom and a pair of opposed side walls extending from the bottom thereof;
a first transducer element disposed in the first channel and a spacer disposed between the first transducer element and the bottom of the first channel; and
a second transducer element disposed in the second channel and a spacer disposed between the second transducer element and the bottom of the second channel;
wherein a polyurethane filler seals the transducer array in the recess of the elongate housing.

10. A bathymetry sonar device as claimed in claim 9 further including a holder disposed in the recess of the elongate housing and wherein the transducer array is set in the holder.

11. A bathymetry sonar device as claimed in claim 10 wherein the holder is constructed from polyvinyl chloride.

12. A bathymetry sonar device as claimed in claim 10 wherein the polyurethane filler seals the holder in the recess of the elongate housing.

13. A bathymetry sonar device as claimed in claim 9 further including an acoustic shield disposed adjacent to the transducer array.

14. A bathymetry sonar device as claimed in claim 13 wherein the polyurethane filler seals the acoustic shield in the recess of the elongate housing.

15. A bathymetry sonar device as claimed in claim 9 further including:
a transmitter; and
an acoustic muffler;
wherein the transmitter and transducer array are both disposed along a longitudinal axis of the bathymetry sonar device, and the acoustic muffler is disposed between the transmitter and transducer array.

16. A bathymetry sonar device as claimed in claim 15 wherein the acoustic muffler includes a plurality of spaced apart plates extending generally perpendicular to the longitudinal axis of the bathymetry sonar device.
